(19) United States
(12) Patent Application Publication
(10) Pub. No.: US 2001/0009417 A1
(43) Pub. Date: Jul. 26, 2001

(54) Information display device and information display system

(76) Inventors: Katsuhiko Asai, Takatsuki-Shi (JP); Sadafusa Tsuji, Tondabayashi-Shi (JP); Katsuyuki Nanba, Sakai-Shi (JP); Masahiko Matsuura, Suita-Shi (JP); Makiko Mandai, Takatsuki-Shi (JP)

Correspondence Address: SIDLEY AUSTIN BROWN & WOOD, 717 NORTH HARWOOD, SUITE 3400, DALLAS, TX, 75201, US

(21) Appl. No.: 09/767,251

(22) Filed: Jan. 22, 2001

(30) Foreign Application Priority Data
Jan. 25, 2000 (JP) 2000-016126

(51) Int. Cl. G09G 5/00

(52) U.S. Cl. 345/204

(57) ABSTRACT

An information display device and an information display system is disclosed. The information display device includes a display panel for displaying electronic information and a control unit for updating a display content in the display panel. The control unit can select a display mode that prohibits the next display update from being performed, at least while a display update is occurring in the display panel.

### RELATED APPLICATIONS

This application is based on application JP 2000-16126 filed in Japan, the contents of which are hereby incorporated by reference.

### FIELD OF THE INVENTION

The present invention relates to an information display device and an information display system, and more particularly to a display device and a display system by which to display various types of information, including characters and images.

### BACKGROUND OF THE INVENTION

Outdoor and indoor advertising generally comprises printed materials or paintings. When the contents of the advertising are to be changed or updated, the printed materials, etc. must be replaced each time such a change is desired, which is inconvenient. Consequently, Japanese Laid-Open Patent Application (Hei) 10-63212 and Japanese Laid-Open Patent Application (Hei) 5-264954 disclose an advertising display system that is capable of displaying advertising based on electronic information and by which the contents of the advertising display may be changed based on the issuance of an instruction from a host device.

The ability to update the contents of the advertising display, based on an update instruction from a host device, offers the advantage that multiple display devices installed in remote locations may be controlled simultaneously. However, it introduces the problems that (i) when there are numerous display devices, it is difficult to cause certain display devices to display a certain content, and (ii) the display devices cannot be moved to locations that have no network connections, or that are inaccessible to radio waves. Also, if communication to the display devices fails, update instructions may not be received.

Therefore, an operating member comprising an operation key, etc. may be included in the display device, such that display update may be carried out through direct operation of each display device. In this case, the operator may conveniently use the operating member to select a desired screen to be displayed from among multiple display screens.

However, it is possible that, while the operator is changing the screen on an individual display through the use of the operating member, the screen is at the same time being updated unilaterally in accordance with an instruction from the host device, and therefore, the problem arises that the screen desired by the operator is not displayed.

### SUMMARY OF THE INVENTION

Therefore, an object of the present invention is to provide an information display device and an information display system that are easy to use and by which the display that is based on electronic information may be updated.

Another object of the present invention is to provide an information display device and an information display system by which display update may be completed, and by which the viewer can view all display contents.

Yet another object of the present invention is to provide an information display device and an information display system that are capable of quickly displaying prescribed display information that is deemed high-priority, such as emergency information.

Yet another object of the present invention is to provide an information display device and an information display system by which the operator can directly update the display using an operating member such as an operation key or a touch panel, such that the operator's desired display information may be displayed.

Yet another object of the present invention is to provide an information display device and an information display system having superior operability, by which the display information desired by the operator is reliably displayed.

Yet another object of the present invention is to provide an information display device and an information display system that contribute significantly to power conservation.

Yet another object of the present invention is to provide an information display device and an information display system that are capable of performing highly expressive display.

In order to attain the objects identified above, a first information display device pertaining to the present invention includes a display panel by which to display electronic information and a control unit that updates the display content in the display panel, wherein the control unit can prohibit the next display update at least while a display update is occurring in the display panel.

The first information display device having the above construction may prohibit the next display update from being performed while the display panel is being updated, and thereafter complete the display update. Therefore, the viewer of the display device may view all of the display contents. Where the next display update is prohibited for a prescribed period of time after the completion of the display update, as well as during the display update, all display contents may be viewed with increased ease.

A second information display device pertaining to the present invention includes a display panel by which to display electronic information, a receiving unit that receives an update instruction from an external apparatus, such as a host device, and a control unit that updates the display content in the display panel based on the update instruction from the external apparatus, wherein the control unit can prohibit a next display update that is based on the update instruction from the external apparatus, at least while a display update is occurring in the display panel.

In the second information display device having the above construction, unilateral update based on an update instruction from the external apparatus may be prevented during display update. Therefore, the viewer of the display device may view all the display contents. Where the display update, based on the update instruction from the external apparatus, is prohibited for a prescribed period of time after the completion of the display update as well as during the display update, all display contents may be viewed with increased ease.

In the second information display device, the control unit can select a first display mode by which a next display update, which is based on the update instruction from the external apparatus, is prohibited at least while a display update is occurring in the display panel. The control unit can also select a second display mode by which display update based on an update instruction from the external apparatus, which is not of a high priority, is prohibited. Display may thus be performed independently of the external apparatus when the second display mode is selected, such that the display contents may be reliably viewed.

In the second information display device where a high-priority update instruction, such as an instruction to display emergency information, for example, is received from the external apparatus and display update based on this instruction from the external apparatus is to be carried out on a priority basis, the high-priority information may be quickly displayed.

Where the second information display device includes a memory that stores the update instruction from the external apparatus and the display is updated based on the update instruction stored in the memory when the display update in the display panel is completed, update based on the update instruction from the external apparatus is executed after the completion of display update, and therefore, display based on update instruction from the external apparatus may be reliably carried out.

A third information display device pertaining to the present invention includes a display panel by which to display electronic information, a receiving unit that receives an update instruction from an external apparatus, an operating member by which to update the display content in the display panel, and a control unit that updates the display in the display panel based on the update instruction from the external apparatus or on an operation of the operating member, wherein the control unit may prohibit a display update that is based on the update instruction from the external apparatus, at least while the operating member is being operated.

In the third information display device having the above construction, the operator can perform display update and display the desired display information using the operating member, such as an operation key or a touch panel. During a display update performed using the operating member, the display is prevented from being unilaterally updated based on an instruction from the external apparatus. Therefore, the display information desired by the operator is reliably displayed and the operability of the device is well maintained. Where a display update, based on instruction information from the external apparatus, is prohibited for a prescribed period of time after the completion of the operation of the operating member as well as during the operation thereof, all display contents may be viewed with increased ease.

In the third information display device, the control unit can select a first display mode by which a next display update, which is based on the update instruction from the external apparatus, is prohibited at least while the operating member is being operated. The control unit can also select a second display mode by which display update based on an update instruction from the external apparatus, which is not of a high priority, is prohibited. Display may thus be performed independently of the external apparatus when the second display mode is selected, such that the desired display information may be reliably displayed.

In the third information display device, where high-priority instruction information such as an instruction to display emergency information, for example, is received from the external apparatus and display update, based on this instruction from the external apparatus, is to be carried out on a priority basis, the prescribed display information that should be given priority may be quickly displayed. Therefore, the operator can be reliably notified of prescribed display information that should be displayed on a priority basis.

Where the third information display device includes a memory that stores an update instruction from the external apparatus and the display is updated based on the update instruction stored in the memory when the operation of the operating member is completed, display update based on the update instruction from the external apparatus is executed after completion of such operation, and therefore, display based on the update instruction from the external apparatus may be reliably carried out.

A first information display system pertaining to the present invention comprises (a) a host device, and (b) a display device including a display panel by which to display electronic information, a receiving unit that receives an update instruction from the host device, and a control unit that updates the display panel in the display device based on the update instruction from the host device, wherein the control unit can prohibit a next display update that is based on the update instruction from the host device, at least while display update is occurring in the display device.

A second information display system pertaining to the present invention comprises (a) a host device, and (b) a display device including a display panel by which to display electronic information, a receiving unit that receives an update instruction from the host device, an operating member by which to instruct display update in the display panel, and a control unit that updates the display in the display panel based on the update instruction from the host device or on an operation of the operating member, wherein the control unit can prohibit a next display update that is based on the update instruction from the host device, at least while the operating member is being operated.

In the second information display system having the above construction, priority may be placed on the operation by the operator even where the host device instructs display update while the operator is using the operating member. Consequently, the display information desired by the operator may be reliably displayed, and the operability of the device may be well maintained.

In the first and second information display systems, the control unit of the display device may include a selector that can select a first display mode that prohibits display update based on the update instruction from the host device, at least during display update or while the operating member is being operated. The selector can select a second display mode that prohibits performance of a display update that is based on an update instruction from the host device that is not of a high priority.

In the first, second and third information display devices and the first and second information display systems, the display panel may comprise a liquid crystal display element having a memory function. Because power consumption is not needed to maintain the display, the display panel thus contributes significantly to power conservation. If the display panel comprises a liquid crystal display element using liquid crystal that exhibits a cholesteric phase, high-resolution and bright images may be displayed, and multi-color display may also be easily performed, so that highly expressive display may be possible.

### BRIEF DESCRIPTION OF THE DRAWINGS

A more complete understanding of the present invention and its advantages will be readily apparent from the following Detailed Description of the Preferred Embodiments taken in conjunction with the accompanying drawings. Throughout the accompanying drawings, like parts are designated by like reference numbers.

FIG. 1 is a drawing showing the overall construction of an electronic advertising system according to one embodiment of the present invention;

FIG. 2 is a perspective view showing an advertising display device according to one embodiment of the present invention;

FIG. 3 is a cross-sectional view showing one example of a liquid crystal display element forming the display panel of the advertising display device;

FIG. 4 is a plan view showing the film substrate of the liquid crystal display element, on which column-shaped bodies and a sealing member are formed;

FIG. 5 is a drawing showing one example of a manufacturing process for the liquid crystal display element;

FIG. 6 is a block diagram showing the drive circuit for the liquid crystal display element;

FIG. 7 is a block diagram showing the control unit of the advertising display device;

FIG. 8 is a perspective view showing the remote controller used in the advertising display device;

FIG. 9 is a block diagram showing the control unit of the remote controller;

FIGS. 10(A) through 10(C) are drawings showing examples of displays that are available using the advertising display device;

FIGS. 11(A) and 11(B) are drawings showing examples of displays that are available using the advertising display device;

FIG. 12 is a flow chart showing a control sequence of the advertising display device; and

FIG. 13 is a flow chart continued from FIG. 12, showing the control sequence of the advertising display device.

### DETAILED DESCRIPTION OF THE PREFERRED EMBODIMENTS

Embodiments of the information display device and information display system pertaining to the present invention are explained below with reference to the accompanying drawings.

### Construction of Electronic Advertising System

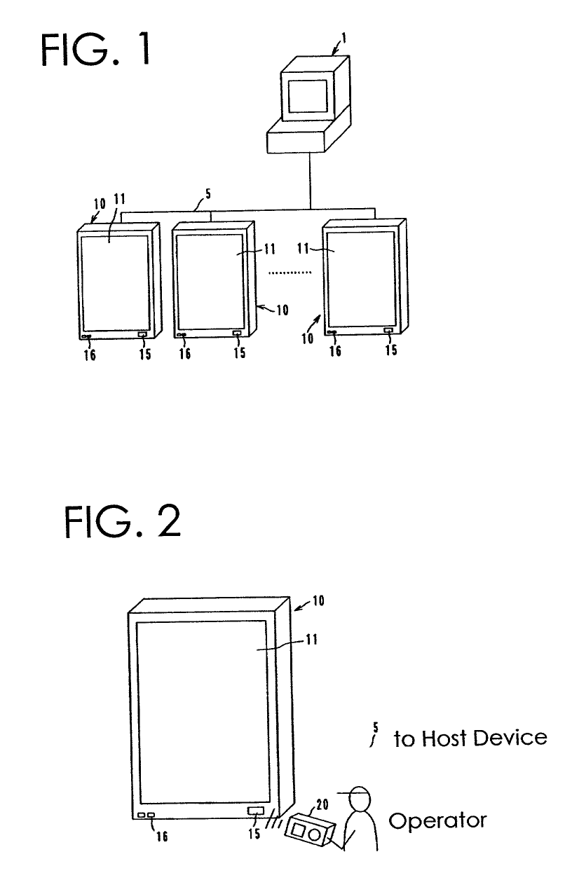

FIG. 1 shows the overall construction of an embodiment of an information display system. The information display system in this embodiment is an electronic advertising system that essentially comprises a host device 1 and multiple advertising display devices 10. The host device 1 is connected to each advertising display device 10 via a connecting line 5 (a communications link such as a dedicated cable, telephone line, etc.).

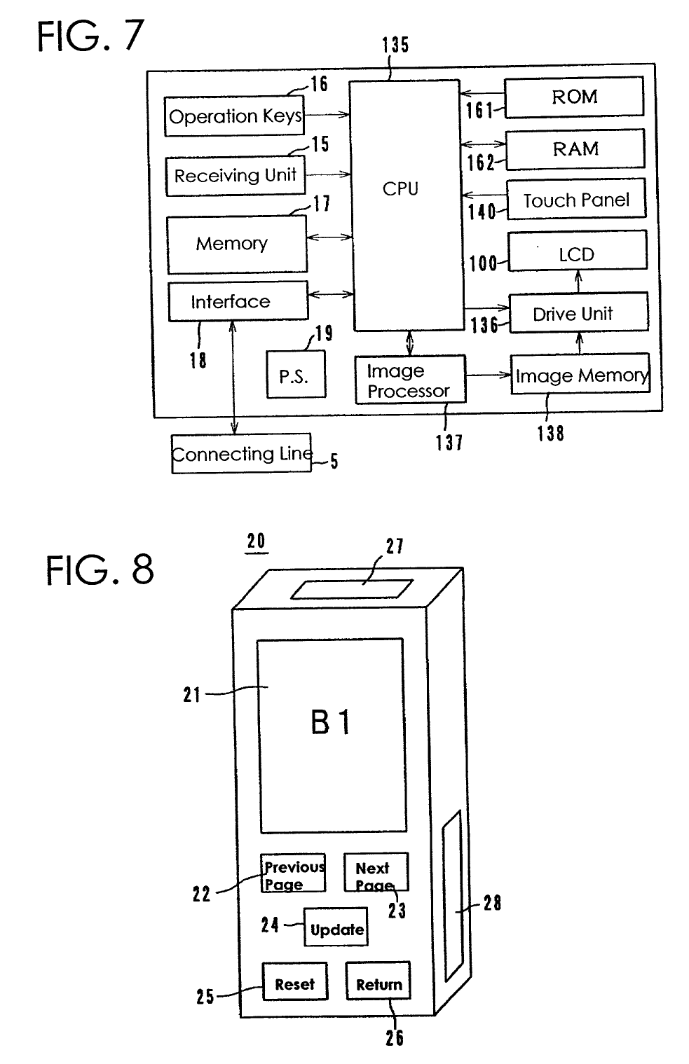

Each advertising display device 10 has a display panel 11 on its front for displaying advertising information in electronic form. The advertising information is stored in non-volatile memory 17 (see FIG. 7) and may consist of single-screen information or multiple advertising data groups including multi-screen information. Each advertising display device 10 displays a prescribed item of information or screen from among the advertising information items stored in the non-volatile memory 17, based on an instruction transmitted from the host device 1. The host device 1 can simultaneously transmit an instruction to multiple advertising display devices 10 and instruct update of the contents of the display devices 10 (the state in which this capability is present is hereinafter referred to as “the first mode”). Naturally, it is also acceptable if the construction of the system is such that the host device 1 may issue an update instruction to each advertising display device 10 on an individual basis.

The display panel 11 comprises a liquid crystal display element having a memory function, which is described in detail below. While power must be supplied when an image is written to the display panel 11, once the image is written, the display is maintained without the need for a power supply.

In the advertising display device 10, display update may also be performed by operating an operating member, such as a remote controller 20 (see FIG. 2), or the operation key 16 or touch panel 140 (see FIG. 7) present in each display device 10, as explained below. Even when the first mode is selected, a display update that is instructed by the host device 1 is not carried out while the remote controller 20, operation key 16 or touch panel 140 is being operated.

Wireless communications may be used to connect the host device 1 and the advertising display devices 10 in place of the connecting line 5. The advertising information to be displayed may be transmitted from the host device 1 or may already be stored in the non-volatile memory 17.

Alternatively, each advertising display device 10 may, on an individual basis, be set such that update instructions from the host device 1 are invalidated (the state in which this capability is present is hereinafter referred to as “the second mode”). When the second mode is activated, the display contents are not updated based on an instruction from the host device 1, and the existing display contents are maintained. Switching between the first mode and the second mode is carried out through the issuance of an instruction via a remote controller 20, which is explained below, or via the operation key 16 or touch panel 140 in the main unit of each advertising display device 10. Even when the second mode is selected, when emergency information is to be displayed, as explained below, priority is placed on the display of the emergency information.

Each advertising display device 10 has a receiving unit 15 that receives information from a remote controller 20 (see FIG. 2). The remote controller 20 is used by the operator to individually operate each advertising display device 10. The remote controller 20 can transmit an instruction to update the display contents in the display panel 11 independently of any instructions received from the host device 1. It is also acceptable if advertising information is stored in the remote controller 20, such that advertising information is transmitted to the advertising display device 10 from the remote controller 20 via the receiving unit 15. In any event, the display contents may by directly updated through operation of the remote controller 20 by the operator, as well as through simultaneous display update based on an instruction from the host device 1. Therefore, an update instruction from the remote controller 20 may be given priority over an update instruction from the host device 1. Additionally, display update may be directly instructed by the remote controller 20 when the advertising display device 10 is moved to a location that has no network connection, is inaccessible to radio waves, or when communication from the host device 1 fails.

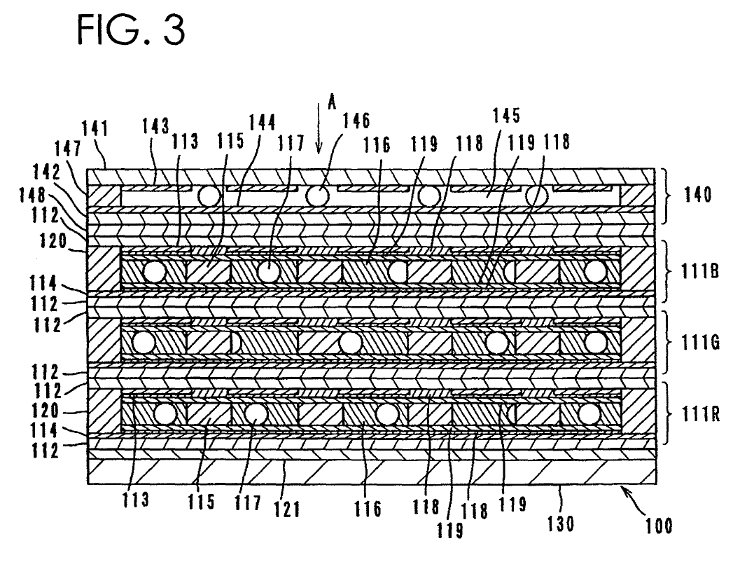

In addition, an operation key 16 is included in the main unit of the advertising display device 10 for the purpose of direct operation, such that the display contents may be updated through the operation of the operation key 16, as well as through the display update operation carried out via the remote controller 20. Further, a touch panel 140 is located on the display panel 11 (see FIGS. 3 and 7). In order to display and view a prescribed item from among the advertising information items stored in the non-volatile memory 17, the viewer of the advertising may select the item by operating the operation key 16 or the touch panel 140.

### Liquid Crystal Display Element

A liquid crystal display element, which includes liquid crystal that exhibits a cholesteric phase, and the touch panel 140 that are used in the display panel 11 will now be explained.

FIG. 3 shows an example of a reflective liquid crystal display element. This liquid crystal display element 100 comprises a light absorbing layer 121 placed on a support plate 130 that comprises a hard material used to prevent the liquid crystal display element 100 from bending, a red display layer 111R that performs display based on switching between the selective reflection of red and a transparent state, and is placed on top of the light absorbing layer 121, a green display layer 111G that performs display based on switching between the selective reflection of green and a transparent state and is placed on top of the red display layer 111R, and a blue display layer 111B that performs display based on switching between the selective reflection of blue and a transparent state, and is placed on top of the green display layer 111G.

A reflective liquid crystal display element that uses the selective reflection characteristic of the cholesteric phase performs display by reflecting external light, and therefore does not require backlighting. The reflective liquid crystal display element thus consumes less power and is capable of providing a display that does not cause eyestrain.

The touch panel 140 is located on the surface of the liquid crystal display element 100 via a protective layer 148 comprising a hard resin material. The protective layer 148 is used in order to prevent a force from acting on a localized area of the liquid crystal display element 100. The construction of this touch panel 140 is conventionally known in the art. It comprises belt-shaped transparent electrodes 143 and 144, which are held between transparent substrates 141 and 142 such that they form matrix-configured sensors. The gap between the transparent substrates 141 and 142 is maintained at a prescribed distance using particle spacers 146 and a sealing member 147, which is located on the edges of the transparent substrates 141 and 142, so that an air layer 145 is contained therebetween. The points at which the belt-shaped transparent electrodes 143 and 144 cross form sensors, and these sensors correspond to each pixel of the display layers 111R, 111G and 111B, which are explained below.

Each display layer 111R, 111G and 111B comprises transparent substrates 112, on which are formed transparent electrodes 113 and 114, as well as column-shaped resin bodies 115, liquid crystal 116 and spacers 117 that are held between the transparent substrates 112. An insulating film 118 and an orientation control film 119 are placed on the transparent electrodes 113 and 114 where necessary. A sealing member 120 to contain the liquid crystal 116 is located at the edges of the transparent substrates 112 (outside the display area).

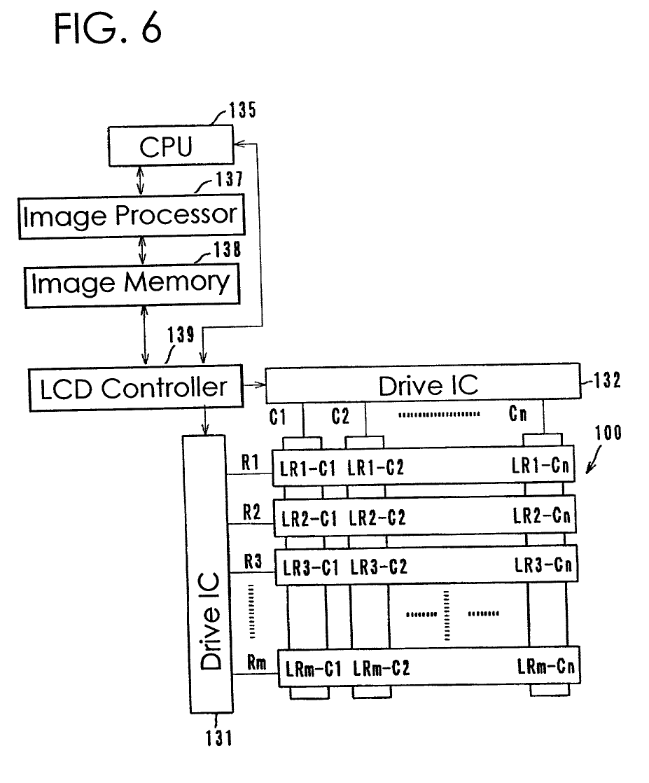

The transparent electrodes 113 and 114 are each connected to a drive IC 131 or 132, respectively (see FIG. 6), and a prescribed pulse voltage is applied between the transparent electrodes 113 and 114. The liquid crystal 116 alternates between a transparent state in which the liquid crystal 116 allows the visible light to pass through, and a selective reflection state in which it selectively reflects the visible light of a particular wavelength, changing the display accordingly.

The transparent electrodes 113 and 114 in each display layer 111R, 111G and 111B comprise multiple belt-shaped electrodes arranged such that they are parallel to each other with a very small distance therebetween. The transparent electrodes 113 and the transparent electrodes 114 are made to face each other such that the orientations of the belt-shaped electrodes are mutually perpendicular. Power is sequentially supplied to these top and bottom belt-shaped electrodes. In other words, a voltage is sequentially applied to the liquid crystal 116 in a matrix fashion so that display is performed. This is termed matrix driving. By sequentially or simultaneously carrying out this matrix driving for each display layer, a multi-color image is displayed on the liquid crystal display element 100.

More specifically, a liquid crystal display element having liquid crystal that exhibits a cholesteric phase and is held between the two substrates performs display by switching the state of the liquid crystal from a planar state to a focal conic state and vice versa. Where the liquid crystal is in the planar state, if the helical pitch of the cholesteric liquid crystal molecules is P and the average refractive index of the liquid crystal is n, the light having a wavelength λ= P·n is selectively reflected. When the liquid crystal is in the focal conic state, if the selective reflection wavelength of the cholesteric liquid crystal is in the infrared range, the liquid crystal diffuses the visible light. However, where the selective reflection wavelength is shorter than the infrared range, the liquid crystal allows the visible light to pass through. Therefore, by setting the selective reflection wavelength to the visible light range, and by placing a light absorbing layer on the side of the element opposite the observation side, a selective reflection color may be displayed when the liquid crystal is in the planar state, and black may be displayed when the liquid crystal is in the focal conic state. By setting the selective reflection wavelength to be in the infrared range and placing a light absorbing layer on the side of the element opposite the observation side, black is displayed when the liquid crystal is in the planar state because it reflects light having a wavelength in the infrared range, but allows the light having a wavelength in the visible light range to pass through, and white is displayed based on diffusion when the liquid crystal is in the focal conic state.

The liquid crystal display element 100 comprising stacked display layers 111R, 111G and 111B is capable of displaying red by setting the blue display layer 111B and the green display layer 111G to the transparent state, in which the liquid crystal molecules are arranged in a focal conic fashion, and by setting the red display layer 111R to the selective reflection state, in which the liquid crystal molecules are arranged in a planar fashion. It can display yellow by setting the blue display layer 111B to the transparent state, in which the liquid crystal molecules are arranged in a focal conic fashion, and by setting the green display layer 111G and the red display layer 111R to the selective reflection state, in which the liquid crystal molecules are arranged in a planar fashion. Similarly, by appropriately switching the state for each display layer between the transparent state and the selective reflection state, red, green, blue, white, cyan, magenta, yellow and black may be displayed. Further, the selection of an intermediate selective reflection state as the state for each display layer 111R, 111G and 111B enables display of intermediate colors, so that the liquid crystal element may be used as a multi-color display element.

For the transparent substrate 112, a clear glass panel or transparent resin film may be used.

For the transparent electrodes 113 and 114, transparent electrodes formed of indium tin oxide (ITO) may be used. Metal electrodes formed of aluminum, silicon, etc., or photoconductive film made of amorphous silicon, bismuth silicon oxide (BSO), etc., may also be used. For the bottommost transparent electrodes 114, black electrodes may be used so that they can also function as light absorbers.

Inorganic film made of silicon oxide or organic film made of polyamide resin, epoxy resin, etc. is used for the insulating film 118 such that it also functions as a gas barrier layer. The insulating film 118 prevents short-circuiting between the transparent substrates 112 and improves the reliability of the liquid crystal. Polyimide is a representative material used for the orientation control film 119.

For the liquid crystal 116, those liquid crystal materials that exhibit a cholesteric phase at room temperature are preferred. In particular, chiral nematic liquid crystal that is obtained by adding a chiral dopant to nematic liquid crystal is preferred.

A chiral dopant is an additive that twists the nematic liquid crystal molecules when added to nematic liquid crystal. By adding a chiral dopant to nematic liquid crystal, a helical construction is obtained in which the liquid crystal molecules are twisted at a certain helical pitch, and a cholesteric phase is thereby exhibited.

The pitch of the helical construction in chiral nematic liquid crystal may be changed by changing the amount of the chiral dopant added. This offers the advantage that the selective reflection wavelength of the liquid crystal may be controlled using this characteristic. In general, the term ‘helical pitch’, which is defined as the distance between molecules when the liquid crystal molecules revolve 360° along the helical construction, is used to express the pitch of the helical construction.

The column-shaped resin bodies 115 may use a material such as thermoplastic resin, for example. It is desired that the material of the column-shaped resin bodies 115 be a material that softens when heated and hardens when cooled, does not cause a chemical reaction with the liquid crystal material used, and has an appropriate level of elasticity.

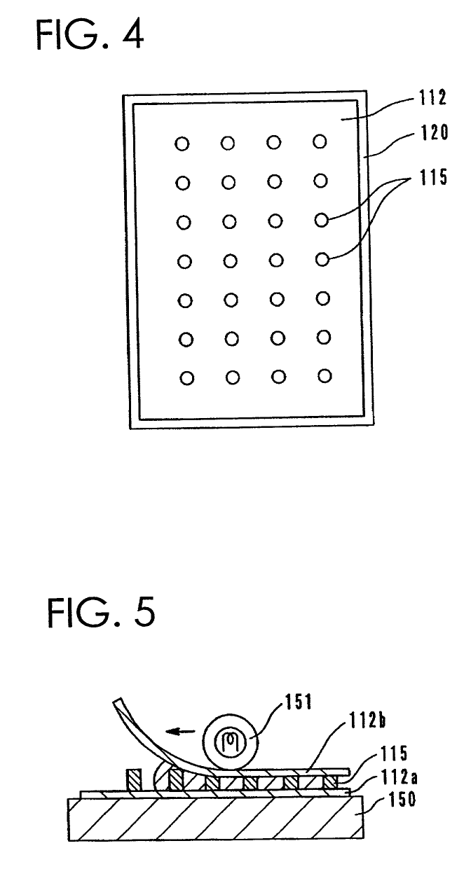

To create the column-shaped bodies 115, the above material is printed using a pattern such that dot-shaped columns are formed, as shown in FIG. 4, based on a public-domain printing method. Appropriate selection is made as to the size of the cross-sectional area, alignment pitch and configuration (cylindrical configuration, drum configuration, polygonal cylindrical configuration, etc.) depending on the size and the pixel resolution of the liquid crystal display element 100. It is preferred that the column-shaped resin bodies 115 be placed between transparent electrodes 113 on a priority basis because this will increase the amount of display area available for actual display.

For the spacers 117, particles formed of a hard material that does not undergo deformation due to heat or pressure are preferred. For example, particles made of an inorganic material such as crushed glass fiber, ball-shaped silicate glass or aluminum powder, or organic synthetic spherical particles made of divinyl benzene bridged polymers or polystyrene bridged polymers may be used.

By including hard spacers 117 that maintain the gap between the two transparent substrates 112 at a prescribed distance and column-shaped resin bodies 115 that are aligned based on a prescribed alignment principle in the display area, and that use, as the main ingredient, a thermoplastic polymer material that bonds and supports the pair of transparent substrates 112, the transparent substrates 112 may be strongly supported throughout their entirety. No unevenness in alignment occurs, and moreover, the generation of air bubbles at low temperatures may be prevented. Incidentally, the spacers 117 are not essential.

An example of the manufacture of the liquid crystal display element 100 will now be briefly explained.

First, multiple belt-shaped transparent electrodes are formed on each of two transparent substrates. The transparent electrodes are formed by forming an ITO film on the substrate via sputtering and performing patterning using photolithography.

A transparent insulating film and orientation control film are then formed on the side of the substrate on which the transparent electrodes are formed. The insulating film and the orientation control film may be formed using a public domain method, such as sputtering, spin coating or roll coating, using an inorganic material such as silicon oxide or an organic material such as polyimide resin. The orientation control film generally is not processed via rubbing. Although the fundamental principle of operation of the orientation control film is not yet entirely clear, it seems that the existence of an orientation control film imparts a certain anchoring effect to the liquid crystal molecules, permitting the characteristics of the liquid crystal display element to be prevented from changing over time. It is also acceptable if a pigment is added to these films such that they can function as color filters, in order to increase color purity and contrast.

Column-shaped bodies are formed on the electrode side of one substrate, on which transparent electrodes, an insulating film and an orientation control film have been formed. Column-shaped bodies may be formed via printing in which a resin material paste comprising resin dissolved in a solvent is extruded by a squeegee via a screen plate or a metal mask onto the substrate which is placed on a flat surface, the dispenser or inkjet method in which the resin material is expelled from the tips of nozzles onto the substrate, or the transfer method in which the resin material is supplied on a flat plate or a roller, and is then transferred onto the substrate surface. It is desired that the height of the column-shaped bodies, once they have been formed, be larger than the thickness of the desired liquid crystal display layer.

A sealing member is placed on the electrode side of the other substrate using a UV-cured resin, a heat-cured resin or the like. The sealing member is placed on the edges of the substrate in the form of a continuous ring. The sealing member may be applied using the dispenser or inkjet method in which the resin is expelled from the tips of nozzles onto the substrate, the printing method in which a screen plate or metal mask is used, or the transfer method in which the resin is formed on a flat plate or a roller and is then transferred onto the transparent substrate, as in the case of the column-shaped bodies. Spacers are then dispersed on the surface of at least one substrate using a conventional public domain method.

The pair of substrates are then placed one on top of the other, such that the electrode sides face each other, and the substrates are heated while being pressurized from either side. The pressurization and heating may be attained by placing the substrate 112a including the column-shaped bodies 115 on a flat plate 150, placing the other substrate 112b over it, and causing them to pass through the gap between a heating/pressurizing roller 151 and the flat plate 150 while heating and pressurizing them from the edge area using the roller 151, as shown in FIG. 5, for example. Using this method, a cell may be manufactured with good accuracy even if flexible substrates having pliability, such as film substrates, are used. If the column-shaped bodies are formed using a thermoplastic polymer material, the column-shaped bodies may be softened via heating and hardened via cooling, such that the two substrates may be bonded together using the column-shaped bodies. When a heat-cured resin material is used for the sealing member, the sealing member should be cured using the heating during this substrate layering process.

In this layering process, a liquid crystal material is dropped onto one substrate, such that the liquid crystal material is injected into the liquid crystal element simultaneously with the layering of the substrates. In this case, spacers should be included beforehand in the liquid crystal material, which is then dropped onto the belt-shaped electrode side of at least one substrate.

By dropping the liquid crystal material onto an edge area of the substrate and spreading it out toward the other edge while layering the substrates using the roller, the liquid crystal material may fill the entire area of the substrate. In this way, the generation of air bubbles and the inclusion thereof during the layering of the substrates may be reduced.

Pressurization of the substrates then continues until the substrate temperature drops to at least the softening temperature (or lower) of the resin material comprising the column-shaped bodies, whereupon the pressurization is stopped. Where a light-cured resin material is used for the sealing member, light is then irradiated onto the substrates in order to cure the material of the sealing member.

Using the same procedure, and changing the liquid crystal material to a material having a different selective reflection wavelength, cells for blue display, green display and red display are manufactured. Three cells thus manufactured are stacked, bonded together using an adhesive, and a light absorbing layer is formed below the bottom layer, whereby a multi-color liquid crystal display element is obtained.

The pixel construction of the liquid crystal display element 100 is expressed in terms of a matrix of multiple scanning electrodes R1, R2, . . . Rm and multiple signal electrodes C1, C2, . . . Cn (n and m being natural numbers), as shown in FIG. 6. The multiple scanning electrodes R1, R2, . . . Rm are connected to the output terminals of the scanning drive IC 131, while the multiple signal electrodes C1, C2, . . . Cn are connected to the output terminals of the signal drive IC 132.

The scanning drive IC 131 outputs a selection signal to prescribed electrodes among the multiple scanning electrodes R1, R2, . . . Rm to set them to the selected state, while it outputs a non-selection signal to other electrodes to set them to the non-selected state. The scanning drive IC 131 sequentially applies the selection signal to the multiple scanning electrodes R1, R2, . . . Rm while switching from one electrode to another at prescribed intervals. At the same time, the signal drive IC 132 simultaneously sends a signal corresponding to the image data to each multiple signal electrode C1, C2, . . . Cn in order to rewrite each pixel on the scanning electrodes R1, R2, . . . Rm that were set to the selected state. For example, where the scanning electrode Ra is selected (a being a natural number that satisfies the equation a≦m), the pixels LRa-C1 through LRa-Cn at the intersection points between this scanning electrode Ra and the multiple signal electrodes C1, C2, . . . Cn are simultaneously rewritten. Consequently, the voltage difference between the scanning electrode and the signal electrode at each pixel becomes the rewrite voltage for that pixel, whereupon the pixel is rewritten in accordance with this rewrite voltage.

The liquid crystal display element 100 used in this embodiment has a large display the size of A0, A1 or A2 paper, for example. Therefore, it is possible that the voltage applied to the scanning electrodes and the signal electrodes will decrease as their distance to the power supply increases. In order to prevent such a reduction in voltage, the conductivity of the multiple scanning electrodes R1, R2, . . . Rm and the multiple signal electrodes C1, C2, . . . Cn should be set such that it increases as the distance of the electrodes from the power supply increases, thereby eliminating the voltage gradient.

The drive unit 136 (FIG. 7) of the liquid crystal display element 100 comprises an LCD controller 139 and the drive ICs 131 and 132. The LCD controller 139 controls the drive ICs 131 and 132 based on the image data stored in the image memory 138, and sequentially applies voltage between each scanning electrode and signal electrode of the liquid crystal display element 100, such that an image is written in the liquid crystal display element 100.

If a first threshold voltage to unwind the twist of the liquid crystal molecules of liquid crystal that exhibits a cholesteric phase is Vth1, the liquid crystal enters the planar state when the voltage Vth1 is applied for a sufficient period of time and the voltage level is then reduced to a level at or below a second threshold voltage Vth2, which is smaller than the first threshold voltage Vth1. If a voltage equal to or larger than Vth2 but equal to or smaller than Vth1 is applied for a sufficient period of time, the focal conic state is attained. These states may be stably maintained without the application of voltage. In addition, by applying a voltage between these levels, halftone display, i.e., gradation display, may be obtained.

Where partial rewrite is desired, only those particular scanning lines which cover the area subject to rewrite should be sequentially selected. In this way, only the needed area is rewritten and thus rewrite can be performed in a short period of time.

Rewriting of each pixel may be performed using the method described above, but where an image is already being displayed, it is preferred that each pixel be reset to the same display state before rewrite is performed in order to eliminate any effect from the existing image. Reset may be performed for all pixels at the same time, or for each scanning electrode on an individual basis. For example, it is known that where each pixel is reset to the focal conic state, a relatively long period of time is required in order to enable a sufficient transparent state to be attained. Thus, if all pixels are simultaneously reset to the focal conic state prior to rewrite, the time required for rewrite is shorter than when reset is performed by each scanning electrode, and therefore this method is preferred.

Where partial rewrite is to be performed, reset should be carried out for each scanning line. Alternatively, only the particular scanning lines that include the area subject to rewrite should be simultaneously reset.

In the above liquid crystal display element 100, the construction of an element in which column-shaped resin bodies are included in the liquid crystal layer was explained. This construction enables the fabrication of a liquid crystal display element that is lightweight and offers superior display characteristics using film substrates, and allows the size of the liquid crystal display element to be easily increased. Furthermore, the element has various superior features, for example, the drive voltage is relatively small, and the element is impact-resistant, which is particularly useful.

The construction of the memory liquid crystal display element itself is not limited to the construction explained above, and the liquid crystal display layer may be formed as a so-called public-domain dispersed polymer liquid crystal composite film, comprising liquid crystal dispersed in a three-dimensional network structure comprising a polymer. Alternatively, a three-dimensional network structure comprising a polymer formed in liquid crystal may be used as well. In addition, an explanation was provided using bistable liquid crystal that exhibits a cholesteric phase as an example of a liquid crystal having a memory function, but the liquid crystal used in the present invention is not limited to this liquid crystal, and another type of memory liquid crystal, such as ferroelectric polymer liquid crystal or ferroelectric liquid crystal, may be used.

FIG. 7 shows the control unit of the advertising display device 10 including the above drive circuit. The control unit includes a central processing unit (CPU) 135, a ROM 161 and a RAM 162. Signals from the receiving unit 15, the operation key 16 and the touch panel 140 are input to the CPU 135. It exchanges information with the non-volatile memory 17 in which advertising information is stored. Furthermore, it also exchanges information with the host device 1 via the connecting line 5 and the interface 18.

The advertising information transmitted from the host device 1 and received via the receiving unit 15 is stored in the non-volatile memory 17. A prescribed advertising information item is then read out from the non-volatile memory 17 based on a command from the CPU 135, and displayed in the liquid crystal display element 100.

The power supply 19 supplies power to each element of this control unit. Because the liquid crystal display element 100 has a memory function, power is required when an image is written. Once writing is completed, however, the display is maintained even if power is no longer supplied to the liquid crystal display element 100. Therefore, power should only be supplied to the liquid crystal display element 100 during image writing, so that power conservation may be attained in the advertising display device 10.

### Remote Controller

The remote controller 20 will now be explained in detail below.

As shown in FIG. 8, the remote controller 20 includes a display panel 21 and operation keys 22 through 26 that are located on the front surface, an infrared transmitter 27 located on the top surface, and a recording medium inlet 28 located on the side. For the recording medium, an optical disk or an IC card in which image data (advertising information) is recorded is used. An element having a memory function, such as the liquid crystal display element 100, is used for the display panel 21, but various other types of display elements may be used instead.

When the recording medium is mounted, the first advertising information item recorded in the recording medium is displayed in the display panel 21. When the previous page operation key 22 or the next page operation key 23 is operated, the advertising information recorded in the recording medium is changed page by page and displayed in the display panel 21. The information displayed in the display panel 21 is the information selected for transmission, so that when the update operation key 24 is operated by the operator while a desired information item is being displayed, the information being displayed is input to the advertising display device 10 via the receiving unit 15, and is displayed in the display panel 11 of the advertising display device 10.

The reset operation key 25 is used to delete the image in the display panel 11 of the advertising display device 10. It may also be assigned a function such as changing the screen to a prescribed wallpaper image. The return operation key 26 is used to return the display in the display panel 11 to the previous screen.

It is also acceptable that display data can be created in the display panel 21 of the remote controller 20. In this case, the remote controller 20 must include an input mechanism such as a keyboard, a pointer, and/or a manual writing input means. It is also acceptable if the functions of the remote controller 20 are simplified to include only update, reset and return. The function to transmit the display information may be omitted as well. In this case, for the information to be displayed in the display panel 11, the operator must select from among the information items stored in the non-volatile memory 17 of the advertising display device 10.

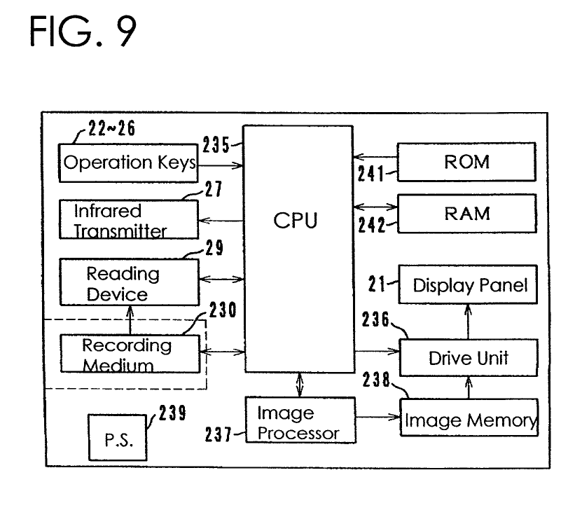

FIG. 9 shows the control unit of the remote controller 20. The construction of the control unit of the remote controller 20 is similar to that of the control unit of the advertising display device 10 (see FIG. 7). In other words, the control unit includes a central processing unit (CPU) 235, a ROM 241 and a RAM 242. Signals from the operation keys 22 through 26 are input to the CPU 235, and the CPU 235 outputs signals to the infrared transmitter 27. The CPU 235 controls the recording medium 230, and reads out its information via the reading device 29. Further, the control unit also includes a drive unit 236 by which to drive the display panel 21, an image processor 237 and an image memory 238. The control unit also includes a power supply 239 that supplies power to each of these elements.

### Display Examples

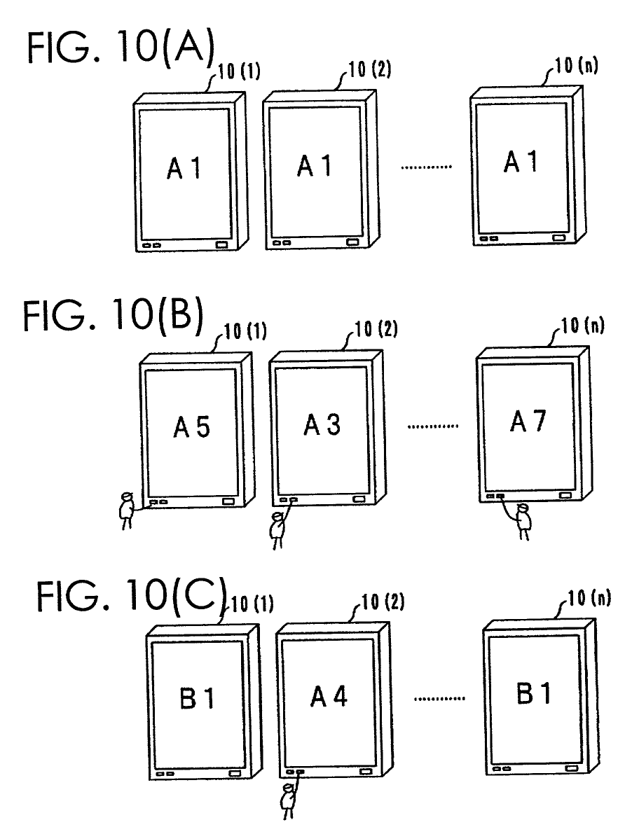

When each advertising display device 10(1), 10(2), . . . 10(n) is instructed by the host device 1 to perform a display update using the first mode so that advertising data groups A1 through Am are displayed, all advertising display devices 10(1), 10(2), . . . 10(n) display advertising having identical content (such as A1, which is the first page data of the advertising data groups A1 through Am), as shown in FIG. 10(A), for example. Once this is done, the viewer of the advertising may select a prescribed item from among the advertising data groups A1 through Am and display the contents of the selected item by operating the operation key 16 or the touch panel 140 of each advertising display device 10 (see FIG. 10(B)).

Now, the host device 1 instructs that the display be changed to advertising data groups B1 through Bn. The advertising display device 10(2), however, is still being operated by a viewer. The display contents are simultaneously updated in the advertising display devices 10(1) through 10(n), with the exception of the advertising display device 10(2), based on the instruction of the host device 1, and the first page data B1 of the advertising data group B1 through Bn is simultaneously displayed, as shown in FIG. 10(C). The original display contents remain displayed in the advertising display device 10(2), however, at least while the operation key 16, the touch panel 140, or the remote controller 20 is being operated, as well as for a prescribed period of time after the completion of such operation.

Immediately after the operation of the operation key 16, the touch panel 140 or the remote controller 20, or when a prescribed period of time has passed after the completion of such operation, the first page data B1 of the advertising data group B1 through Bn is displayed in the advertising display device 10(2) as well.

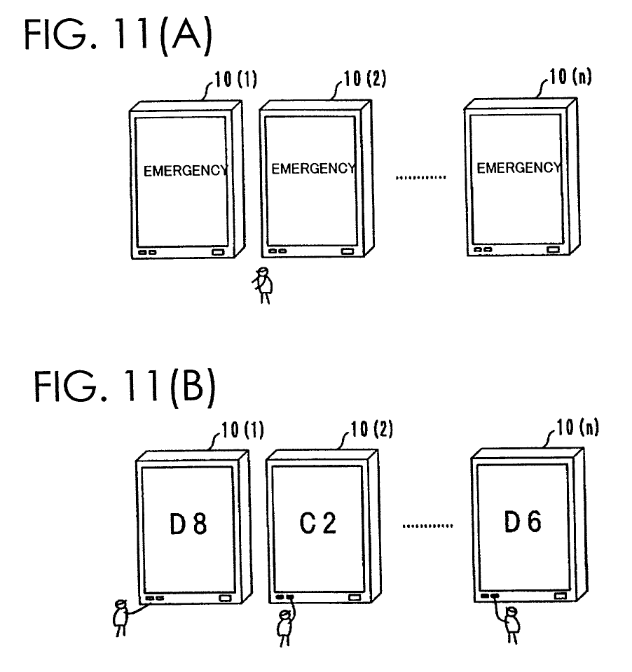

On the other hand, where an emergency update command is issued from the host device 1, all advertising display devices 10 display the same information (emergency information such as earthquake information or a news bulletin, for example), regardless of whether the touch panel 140 or the operation key 16 is being operated in each advertising display device 10 (see FIG. 11(A)).

Where the second mode is selected, instructions from the host device 1 are invalidated and are thus ignored, except when an emergency update command is issued. The advertising display devices 10 in which the second mode is activated thus display information or advertising independently of the instructions from the host device 1 (see FIG. 11(B)).

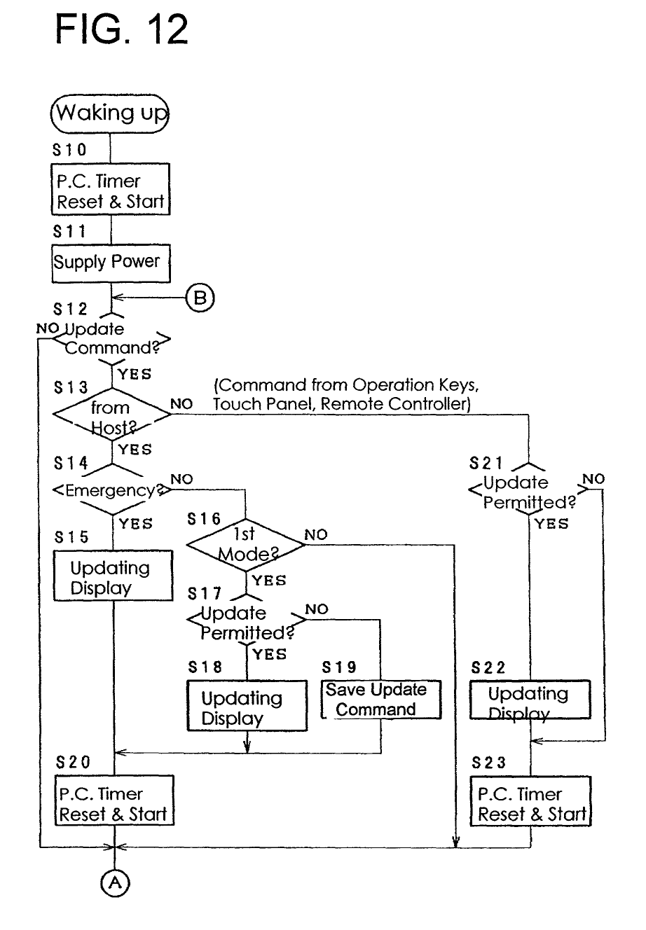

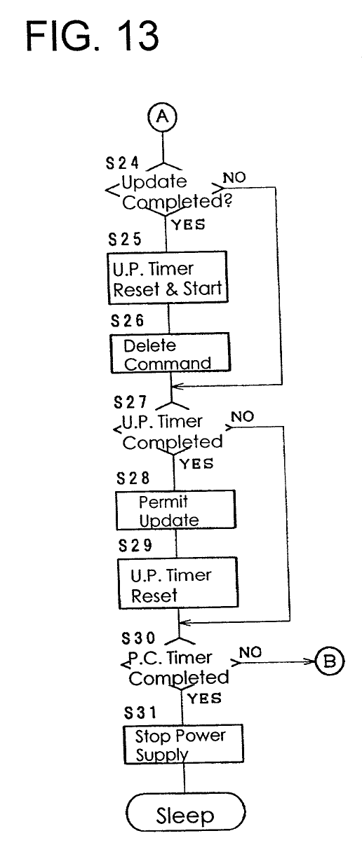

The display examples shown in FIGS. 10(A) through 10(C), 11(A) and 11(B) are displayed in each advertising display device 10 using the control sequence shown in FIGS. 12 and 13.

First, when the operation key 16 or the touch panel 140 is operated, or when an update command is received from the host device 1 or the remote controller 20, the CPU 135, which has been asleep, wakes up, resets and starts the power conservation timer (step S10), and begins supplying power to each element (step S11). Where an update command is not issued (NO in step S12), the CPU 135 moves to step S24. The processing beginning with step S24 is explained below.

Where an emergency update command is issued from the host device 1 (YES in step S13, YES in step S14), the CPU 135 immediately updates the contents of the display based on the instruction of the host device 1 (step S15), and resets and restarts the power conservation timer (step S20). Through this process, regardless of whether or not the first or the second mode is selected, or whether or not the operation key 16 or the touch panel 140 is being operated, the display update instructed by the host device 1 is carried out on a priority basis. Therefore, emergency information such as earthquake information, typhoon information, accident information or a news bulletin may be quickly displayed, and the operator of the operation key 16, etc. may be reliably notified of emergency information as well.

Where a non-emergency update command is received from the host device 1 (NO in step S14), and the first mode is currently active (YES in step S16), the CPU 135 confirms that display update is permitted (YES in step S17), and updates the display to the screen instructed by the host device 1 (step S18). Where display update is not permitted (NO in step S17), the CPU 135 saves the update command in a prescribed area of the memory 17 so that display update may begin when display update becomes permitted (step S19). The CPU 135 then moves to step S20. Where the first mode is not currently active (NO in step S16), the CPU 135 ignores the update command and immediately moves to step S24. As described below, further display update is prohibited while the display is being updated and is permitted only after the current display update is completed.

Where an update command is issued from an element other than the host device 1, i.e., from the operation key 16, the touch panel 140 or the remote controller 20 (NO in step S13), the CPU 135 confirms that display update is permitted (YES in step S21), updates the screen to the instructed screen (step S22), and resets and restarts the power conservation timer (step S23). Where display update is not permitted (NO in step S21), the CPU 135 immediately moves to step S23, thereby invalidating the operation of the operation key 16, etc. during display update (i.e., while the display is updated). Through this process, commencement of a display based on another advertising information item is prevented while the display update is occurring, and the operator can reliably view all display contents.

The CPU 135 determines in step S24 whether the display update has been completed, and where it has been completed, the CPU 135 resets and restarts the update permission timer (step S25), and deletes the update command saved in the previous step S19 (step S26).

Upon confirming that the update permission counter has completed counting (YES in step S27), the CPU 135 permits display update (step S28), and resets the update permission timer (step S29). Because the advertising information obtained as a result of the display update continues to be displayed for at least a prescribed period of time after the operation of the operation key 16, etc. based on this process, viewing of the information is made easy.

The CPU 135 returns to step S12 and repeats the above processing and stands by for an update command until the power conservation timer completes counting (NO in step S30). When the power conservation timer completes counting (YES in step S30), the CPU 135 turns OFF the power supply to each element (step S31) and goes to sleep.

### Other Embodiments

The information display device and the information display system pertaining to the present invention are not limited to the embodiments described above, but may be varied within their essential scope.

In particular, any construction may be used for the external construction of the information display device, the display construction, the location of the operation key, etc.

In addition, the information display device may be used not only as an advertising display device. It may display various types of information including various notices, traffic information, timetables or weather information.

For the recording medium that stores the information to be displayed, in addition to a non-volatile memory, various other types of recording media may also be used, such as an IC card, optical disk or magnetic disk.

Although the present invention has been fully described by way of examples and with reference to the accompanying drawings, it is to be understood that various changes and modifications will be apparent to those skilled in the art without departing from the spirit and scope of the invention. Therefore, unless such changes and modifications depart from the scope of the present invention, they should be construed as being included therein.

What is claimed is:

1. An information display device, comprising:
a display panel for displaying electronic information; and
a control unit for updating a display content in said display panel;
wherein said control unit can prohibit a next display update from being performed at least while a display update is occurring in said display panel.

2. An information display device according to claim 1, wherein said control unit prohibits the next display update from being performed while the display update is occurring.

3. An information display device according to claim 2, wherein said control unit allows the next display update to be performed after a completion of the display update.

4. An information display device according to claim 1, wherein said control unit prohibits the next display update from being performed for a prescribed period of time after a completion of the display update.

5. An information display device according to claim 4, wherein said control unit allows the next display update to be performed when the prescribed period of time has passed after the completion of the display update.

6. An information display device according to claim 1, wherein said information display device further comprises a memory for storing said electronic information.

7. An information display device according to claim 1, wherein said display panel comprises a liquid crystal display element having a memory function.

8. An information display device, comprising:
a display panel for displaying electronic information;
a receiving unit for receiving an update instruction from an external apparatus; and
a control unit for updating a display content in said display panel based on the update instruction from the external apparatus;
wherein said control unit can prohibit a next display update, which is based on the update instruction from the external apparatus, from being performed at least while a display update is occurring in said display panel.

9. An information display device according to claim 8, wherein said control unit prohibits the next display update from being performed while the display update is occurring.

10. An information display device according to claim 9, wherein said control unit allows the next display update to be performed after a completion of the display update.

11. An information display device according to claim 8, wherein said control unit prohibits the next display update from being performed for a prescribed period of time after a completion of the display update.

12. An information display device according to claim 11, wherein said control unit allows the next display update to be performed when the prescribed period of time has passed after the completion of the display update.

13. An information display device according to claim 8, wherein said control unit is responsive to a high-priority update instruction received from the external apparatus so as to permit a display update to be performed.

14. An information display device according to claim 8, wherein said control unit can select a first display mode that prohibits the next display update from being performed at least while the display update is occurring, and a second display mode that prohibits performance of a display update that is based on an update instruction from the external apparatus that is not of a high priority.

15. An information display device according to claim 8, wherein said information display device further comprises a memory for storing the update instruction received from the external apparatus.

16. An information display device according to claim 15, wherein said control unit allows the next display update to be performed, after a completion of the display update, based on the update instruction from the external apparatus that is stored in said memory.

17. An information display device according to claim 8, wherein said display panel comprises a liquid crystal display element having a memory function.

18. An information display device, comprising:
a display panel for displaying electronic information;
a receiving unit for receiving an update instruction from an external apparatus;
an operating member for updating a display content in said display panel; and
a control unit for updating the display content in said display panel based on one of the update instruction from the external apparatus, and an operation of said operating member;
wherein said control unit can prohibit a next display update, which is based on the update instruction from the external apparatus, at least while said operating member is being operated.

19. An information display device according to claim 18, wherein said control unit prohibits the next display update from being performed during an operation of the operating member.

20. An information display device according to claim 18, wherein said control unit prohibits the next display update from being performed for a prescribed period of time after completion of an operation of said operating member.

21. An information display device according to claim 18, wherein said control unit is responsive to a high-priority update instruction received from the external apparatus so as to permit a display update to be performed.

22. An information display device according to claim 18, wherein said control unit can select a first display mode that prohibits the next display update from being performed at least while said operating member is being operated, and a second display mode that prohibits performance of a display update that is based on an update instruction from the external apparatus that is not of a high priority.

23. An information display device according to claim 18, wherein said information display device further comprises a memory for storing the update instruction received from the external apparatus.

24. An information display device according to claim 23, wherein said control unit allows the next display update to be performed, after completion of an operation of said operating member, based on the update instruction from the external apparatus that is stored in said memory.

25. An information display device according to claim 18, wherein said operating member is selected from the group consisting of:
a remote controller;
an operation key; and
a touch panel.

26. An information display device according to claim 25, wherein said remote controller is adapted to store display content information therein.

27. An information display device according to claim 18, wherein said display panel comprises a liquid crystal display element having a memory function.

28. An information display device according to claim 27, wherein said liquid crystal display element uses liquid crystal that exhibits a cholesteric phase.

29. An information display system comprising:
a host device; and
a display device, comprising:
a display panel for displaying electronic information,
a receiving unit for receiving an update instruction from said host device, and
a control unit for updating said display panel in said display device based on the update instruction from said host device,
wherein said control unit can prohibit a next display update, which is based on the update instruction from said host device, at least while display update is occurring in said display device.

30. An information display system according to claim 29, further comprising a second display device, wherein said host device is connected to each of said display device and said second display device via a communications link.

31. An information display system according to claim 30, wherein said host device simultaneously transmits the update instruction to said display device and said second display device.

32. An information display system according to claim 30, wherein said host device individually transmits the update instruction to each of said display device and said second display device.

33. An information display system according to claim 30, wherein said communications link is a wireless communications link.

34. An information display system according to claim 29, wherein said control unit includes a selector that can select a first display mode that prohibits the next display update at least while the display update is occurring, and a second display mode that prohibits performance of a display update that is based on an update instruction from said host device that is not of a high priority.

35. An information display system according to claim 29, wherein said display panel comprises a liquid crystal display element having a memory function.

36. An information display system comprising:
a host device; and
a display device, comprising:
a display panel for displaying electronic information,
receiving unit for receiving an update instruction from said host device,
an operating member by which to instruct display update in said display panel, and
a control unit for performing the display update based on one of the update instruction from said host device, and an operation of said operating member,
wherein said control unit can prohibit a next display update, which is based on the update instruction from said host device, at least while said operating member is being operated.

37. An information display system according to claim 36, further comprising a second display device, wherein said host device is connected to each of said display device and said second display device via a communications link.

38. An information display system according to claim 37, wherein said host device simultaneously transmits the update instruction to said display device and said second display device.

39. An information display system according to claim 37, wherein said host device individually transmits the update instruction to each of said display device and said second display device.

40. An information display system according to claim 37, wherein said communications link is a wireless communications link.

41. An information display system according to claim 36, wherein said operating member is selected from the group consisting of:
a remote controller;
an operation key; and
a touch panel.

42. An information display system according to claim 41, wherein said remote controller is adapted to store display content information therein.

43. An information display system according to claim 36, wherein said control unit includes a selector that can select a first display mode that prohibits the next display update from being performed at least while said operating member is being operated, and a second display mode that prohibits performance of a display update that is based on an update instruction from said host device that is not of a high priority.

44. An information display system according to claim 36, wherein said display panel comprises a liquid crystal display element having a memory function.

45. An information display system according to claim 44, wherein said liquid crystal display element uses liquid crystal that exhibits a cholesteric phase.
